(19) United States
(12) Patent Application Publication
(10) Pub. No.: US 2010/0079068 A1
(43) Pub. Date: Apr. 1, 2010

(54) HIGH-PRESSURE DISCHARGE LAMP

(75) Inventor: Andreas Genz, Berlin (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/563,133

(22) Filed: Sep. 20, 2009

(30) Foreign Application Priority Data
Sep. 29, 2008 (DE) 10 2008 049 476.3

(51) Int. Cl. H01J 61/12; H01J 61/20

(52) U.S. Cl. 313/572; 313/642

(57) ABSTRACT

In various embodiments, a high-pressure discharge lamp has a metal halide fill, iodine and bromine being used as the halogen. In addition, noble gas and Hg are used. Thallium is used as the metal, with the proportion of TlI being in the range from 25 to 75 wt. % of the mixture of TlI and TlBr.

### CROSS-REFERENCE TO RELATED APPLICATION

This application claims priority to German Patent Application Serial No. 10 2008 049 476.3, which was filed Sep. 29, 2008, and is incorporated herein by reference in its entirety.

### TECHNICAL FIELD

Various embodiments are based on a high-pressure discharge lamp. Such lamps may be high-pressure discharge lamps with a ceramic discharge vessel or else a quartz glass vessel for general lighting.

### BACKGROUND

U.S. Pat. No. 4,992,700 has disclosed a high-pressure discharge lamp in which a metal halide fill is used. The high-pressure discharge lamp is used for producing green radiation and contains bromide or iodide of thallium as the metal halide.

### SUMMARY

Various embodiments provide a high-pressure discharge lamp with a metal halide fill with improved maintenance.

In various embodiments, a high-pressure discharge lamp is provided with a bulb, which surrounds a discharge volume, a fill which contains thallium halides, mercury and noble gas from the group consisting of neon, argon, krypton, xenon being accommodated in the discharge volume, wherein the fill at the same time contains the halides of iodine and bromine, the proportion of TlI being at least 25 wt. % and at most 75 wt. %, based on the sum of TlI and TlBr.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a high-pressure discharge lamp with a discharge vessel with a separate outer bulb (a) and an integrated outer bulb (b);

FIG. 2 shows a graph showing the maintenance for different fills in the case of 250 W lamps; and

FIG. 3 shows a graph showing the maintenance for different fills in the case of 400 W lamps.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Colored lamps are gaining increasing importance on the market as effect lighting in architectural lighting. Various embodiments relate to green-emitting metal halide lamps. In this case, in addition to good maintenance, there are in principle other aims: 1. high radiation power in the green region; 2. high color saturation.

The fills used to date for green emission normally use TlI. Theoretically, TlBr has also been investigated, but never used. The use of a mixture has never seriously been considered since this has not promised any additional advantages, but is more complex to produce since the mixture needs to be monitored and adjusted.

Surprisingly, a fill containing a mixture of TlBr+TlI demonstrates improved maintenance in comparison with the previous fill of TlI, on the one hand, and pure TlBr and a mixture of TlI+TlBr+TlCl, on the other hand.

The maintenance, i.e. the constancy of the power emitted in the green spectral region, is thus improved without the other important variable, the color saturation, being impaired.

In this case, the following limit values apply: the proportion of TlI is at least 25 wt. % and at most 75 wt. %.

The fill quantity of the total Tl halide is between 0.1 and 1 mg per ml discharge volume. Particularly preferred are a value of between 0.2 and 1.0 mg/ml for lamps in the power range from 35 to 150 W and a value of between 0.1 and 0.6 mg/ml for lamps of 175 to 1000 W.

The concept according to various embodiments is e.g. suitable for lamps of low and average power in the range from 15 to 1000 W.

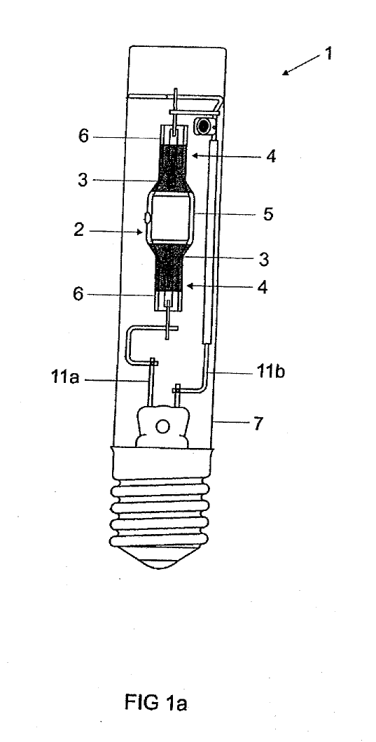

FIG. 1a shows, schematically, a metal halide lamp 1. It includes a discharge vessel 2 consisting of quartz glass, into which two electrodes 3 are introduced. The discharge vessel has a central part 5 and two ends 4. Two pinch seals 6 are positioned at the ends.

The discharge vessel 2 is surrounded by an outer bulb 7. The discharge vessel 2 is held in the outer bulb by means of a frame, which contains a short and a long power supply line 11a and 11b, respectively.

The discharge vessel contains a fill, which typically contains Hg (3 to 30 mg/cm³) and 0.1 to 1 mg/cm³ of a halide of thallium. Argon under a pressure of from 30 to 300 hPa cold is used as the noble gas. Thus, a green-emitting metal halide lamp is realized.

FIG. 1b shows a second embodiment with a discharge vessel 2 consisting of quartz glass, on which an integrated outer bulb 10 is attached without a frame being required. The fill is similar to that in the exemplary embodiment shown in FIG. 1a.

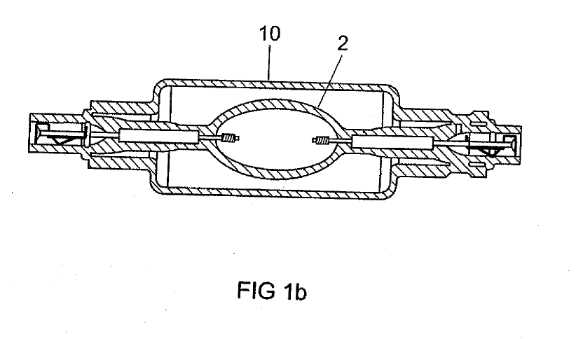

FIG. 2 shows a graph in which the maintenance of different fills of Tl halide for a 250 W lamp are compared with one another. In this case, it is demonstrated that pure TlBr (curve b) and pure TlI (curve a) by far demonstrate the poorest response. The radiation power in the green spectral region decreases from the reference point after 100 hours down to 6000 hours to at most 80% if mixtures are used. By way of example, mixtures of TlI and TlBr demonstrate markedly improved values if the proportion of TlI is between 25 (curve d) and 75 wt. % (curve c). Excellent values are achieved if the proportion of TlI is in the range of from 40 to 60 wt. %. The response for 60 wt. % (curve e) and 50 wt. % (curve f) is shown.

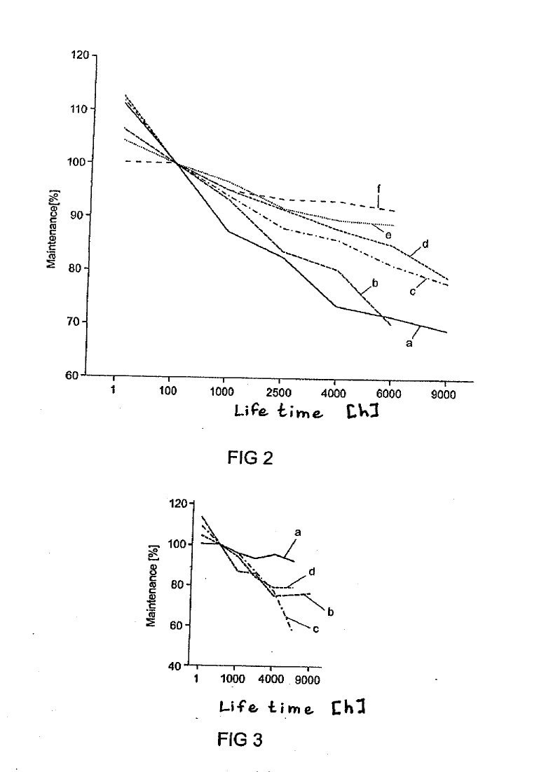

FIG. 3 shows a graph for 400 W lamps, in which the maintenance of a mixture of 55 wt. % of TlI with 45 wt. % of TlBr (curve a) is compared with pure TlI (curve b) and TlBr (curve c), on the one hand, and with a triple mixture (curve d) of proportions of TlI (70 wt. %), TlBr (20 wt. %) and TlCl (10 wt. %), on the other hand. It is demonstrated that the addition of chlorine is similarly disadvantageous to the use of pure halides. It should therefore be added at most in small quantities.

Table 1 shows the light-technical data for various metal halide lamps with a quartz glass bulb as shown in FIGS. 1a and 1b.

TABLE 1

| | FIG. 1b | FIG. 1b | FIG. 1a | FIG. 1b |
|---|---|---|---|---|
| Type | 70 W | 150 W | 250 W | 400 W |
| MH fill quantity | 0.3 mg | 0.8 mg | 0.9 mg | 1.5 mg |
| 55 wt. % of TlI + 45 | | | | |
| wt. % of TlBr | | | | |
| Volumes | 0.7 ml | 1.8 ml | 5.2 ml | 8.0 ml |
| Color saturation at | 38% | 43% | 53% | 48% |
| 100 h | | | | |
| Luminous flux at 100 h | 5 200 lm | 10 500 lm | 23 000 lm | 34 000 lm |
| Radiation power in the | 5 W | 10 W | 29 W | 41 W |
| green 510 to 540 nm at | | | | |
| 100 h | | | | |
| Maintenance after | 80% | 80% | 90% | 90% |
| 6000 h | | | | |
| Hg quantity in mg | 8.0 | 17.0 | 29.0 | 62.5 |

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A high-pressure discharge lamp, comprising:
a bulb, which surrounds a discharge volume;
a fill which contains thallium halides, mercury and noble gas from the group consisting of neon, argon, krypton, xenon being accommodated in the discharge volume;
wherein the fill at the same time contains the halides of iodine and bromine, the proportion of TlI being at least 25 wt. % and at most 75 wt. %, based on the sum of TlI and TlBr.

2. The high-pressure discharge lamp as claimed in claim 1,
wherein the proportion of TlI is at least 40%.

3. The high-pressure discharge lamp as claimed in claim 2,
wherein the proportion of TlI is at least 50%.

4. The high-pressure discharge lamp as claimed in claim 1,
wherein the proportion of TlI is at most 60%.

5. The high-pressure discharge lamp as claimed in claim 1,
wherein the noble gas is selected from a group consisting of:
argon;
krypton; and
neon.

6. The high-pressure discharge lamp as claimed in claim 1,
wherein the coldfilling pressure of the noble gas is selected to be in the range from 30 to 300 hPa.

7. The high-pressure discharge lamp as claimed in claim 1,
wherein the content of Hg is selected to be in the range from 3 to 30 mg/cm³.

8. The high-pressure discharge lamp as claimed in claim 1,
wherein the lamp is a lamp emitting colored light for effect lighting.

9. The high-pressure discharge lamp as claimed in claim 1,
wherein the fill quantity of the total Tl halide is between 0.1 and 1 mg per ml discharge volume.
